(19) United States
(12) Patent Application Publication
(10) Pub. No.: US 2022/0179687 A1
(43) Pub. Date: Jun. 9, 2022

(54) INFORMATION PROCESSING APPARATUS AND JOB SCHEDULING METHOD

(71) Applicant: FUJITSU LIMITED, Kawasaki-shi (JP)

(72) Inventor: Shigeto SUZUKI, Kawasaki (JP)

(73) Assignee: FUJITSU LIMITED, Kawasaki-shi (JP)

(21) Appl. No.: 17/403,921

(22) Filed: Aug. 17, 2021

(30) Foreign Application Priority Data
Dec. 3, 2020 (JP) 2020-200768

(51) Int. Cl. G06F 9/48

(52) U.S. Cl. CPC G06F 9/4881; G06Q 10/06315

(57) ABSTRACT

A memory stores therein group information indicating two or more node groups generated by dividing a set of nodes including a plurality of nodes to execute a plurality of jobs. With respect to each of the plurality of jobs, a processor causes one node group to execute the job. The one node group is selected for the job according to the number of nodes to be used for the job from the two or more node groups indicated by the group information. The processor generates, with respect to each of the two or more node groups, distribution information regarding the waiting times of two or more jobs executed by the node group among the plurality of jobs and changes the group count of the two or more node groups on the basis of the distribution information.

### CROSS-REFERENCE TO RELATED APPLICATION

This application is based upon and claims the benefit of priority of the prior Japanese Patent Application No. 2020-200768, filed on Dec. 3, 2020, the entire contents of which are incorporated herein by reference.

### FIELD

The embodiments discussed herein relate to an information processing apparatus and a job scheduling method.

### BACKGROUND

A large-scale information processing system such as a high performance computing (HPC) system includes a plurality of nodes that each have a processor to execute a program. The information processing system with the plurality of nodes may execute a plurality of jobs requested by different users. A job is a series of information processing. The load of information processing depends on a job. One job may use two or more nodes in parallel. For example, a user specifies the number of nodes used for a job before the job starts.

An information processing system shared by a plurality of users has a scheduler that performs scheduling to assign jobs to nodes. In the case where the number of currently idle nodes is not enough to execute a job, the job waits until as many nodes as needed for the job become idle. There are a variety of scheduling algorithms that are executable by the scheduler. Different scheduling algorithms may set different start times for the same job. That is to say, the choice of what scheduling algorithm to use influences the waiting time of each job.

There has been proposed a distributed processing system that controls assignment of a plurality of jobs to resources. The proposed distributed processing system classifies the plurality of jobs into a group that has a high processor load and does not need many file accesses and a group that has a low processor load and needs many file accesses. The distributed processing system monitors the most recent job execution records and the number of currently waiting jobs on a group-by-group basis and dynamically changes the allocated number of processors and the allocated quantity of work files.

In addition, there has been proposed a job scheduler that performs job scheduling using a two-dimensional map in which the vertical axis represents computing node and the horizontal axis represents time. In the case of receiving a small-scale job that uses a small number of computing nodes after a large-scale job that uses a large number of computing nodes, the proposed job scheduler allows the small-scale job to be executed first using idle computing nodes unless this execution causes a delay in the execution start of the large-scale job.

Please see, for example, Japan Laid-open Patent Publications No. 7-219787 and No. 2012-173753.

In the case where scheduling is performed for large-scale jobs that use large numbers of nodes and small-scale jobs that use small numbers of nodes mixedly, early start of a small-scale job may cause a lack of idle nodes for a large-scale job and thus the large-scale job may have a relatively long waiting time. A big difference in waiting time between the large-scale job and the small-scale job is not desirable for users.

To deal with this, one of methods considered is to divide a set of nodes provided in an information processing system into a node group used for large-scale jobs and a node group used for small-scale jobs and perform scheduling for large-scale jobs and for small-scale jobs separately so that these jobs do not influence each other. However, this arises a problem of how to divide the set of nodes.

### SUMMARY

According to one aspect, there is provided an information processing apparatus including: a memory that stores therein group information indicating two or more node groups generated by dividing a set of nodes including a plurality of nodes used to execute a plurality of jobs; and a processor that is configured to perform a process including: causing, with respect to each of the plurality of jobs, one node group to execute the each of the plurality of jobs, the one node group being selected according to a planned node count of the each of the plurality of jobs from the two or more node groups indicated by the group information, the planned node count indicating a number of nodes to be used for the each of the plurality of jobs, generating, with respect to each of the two or more node groups, distribution information regarding waiting times of two or more jobs executed by the each of the two or more node groups among the plurality of jobs, and changing a group count of the two or more node groups, based on the distribution information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for explaining an information processing apparatus according to a first embodiment;

FIG. 2 illustrates an example of an information processing system according to a second embodiment;

FIG. 3 illustrates a block diagram illustrating an example of hardware configuration of a scheduler;

FIG. 4 illustrates a first example of scheduling result;

FIG. 5 illustrates a second example of scheduling result;

FIG. 6 illustrates graphs each representing an example of the relationship between the number of clusters and waiting time;

FIG. 7 illustrates an example of timing of cluster changes;

FIG. 8 illustrates a graph representing an example of the waiting time differences of clusters;

FIG. 9 illustrates an example of a table indicating used node count conditions;

FIG. 10 illustrates graphs representing the relationship between cluster size and occupancy rate and the relationship between cluster size and waiting time;

FIG. 11 illustrates a block diagram illustrating an example of functions of the scheduler;

FIG. 12 illustrates an example of a cluster table, a node table, and a history table;

FIG. 13 is a flowchart illustrating how to change clusters; and

FIG. 14 is a flowchart illustrating a scheduling procedure.

### DESCRIPTION OF EMBODIMENTS

Hereinafter, some embodiments will be described with reference to the accompanying drawings.

### First Embodiment

A first embodiment will be described.

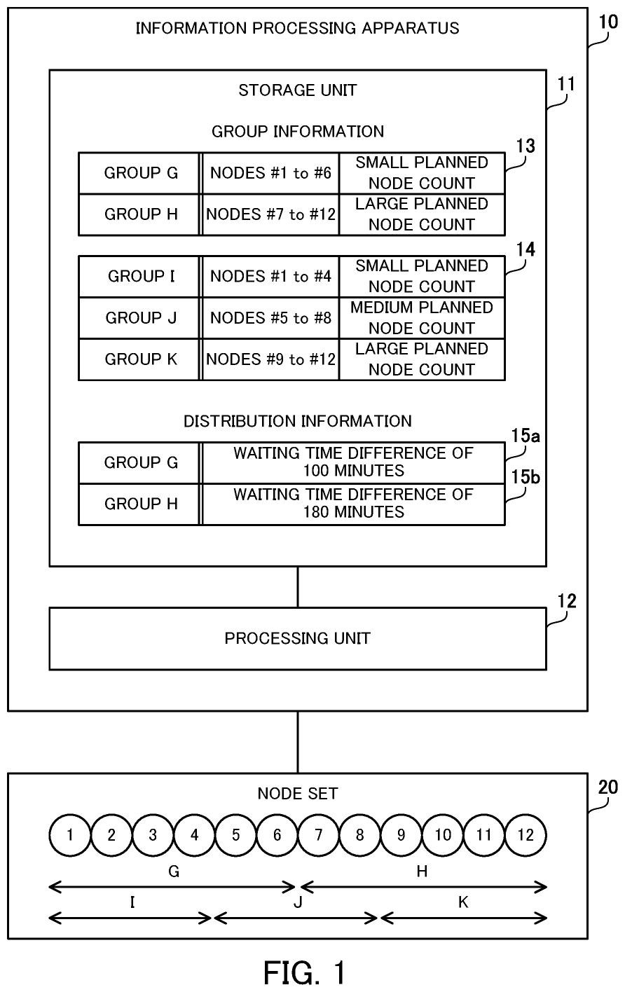

FIG. 1 is a view for explaining an information processing apparatus according to the first embodiment.

The information processing apparatus 10 of the first embodiment performs job scheduling. The information processing apparatus 10 communicates with a set of nodes 20 (hereinafter, referred to as a node set 20) that are used to execute jobs. The node set 20 may be an HPC system. The information processing apparatus 10 may be a client device or a server device. The information processing apparatus 10 may be called a computer or a scheduler.

The information processing apparatus 10 includes a storage unit 11 and a processing unit 12. The storage unit 11 may be a volatile semiconductor memory, such as a random access memory (RAM), or a non-volatile storage device, such as a hard disk drive (HDD) or a flash memory. For example, the processing unit 12 is a processor such as a central processing unit (CPU), a graphics processing unit (GPU), or a digital signal processor (DSP). The processing unit 12 may include an application specific integrated circuit (ASIC), a field programmable gate array (FPGA), or another application-specific electronic circuit. The processor may execute programs stored in a memory such as a RAM (e.g. storage unit 11). A set of processors may be called “a multiprocessor” or simply “a processor.”

The storage unit 11 stores therein group information 13. The group information 13 indicates two or more node groups generated by dividing the node set 20 including a plurality of nodes. For example, each node includes a processor and a memory and runs a program on the processor. The processor may be a processor core. An initial value for a group count indicating the number of groups is two, for example. The node groups may be called clusters. The group information 13 indicates a range of identifiers of the nodes belonging to each node group. The two or more node groups are made up of the same number of nodes or different numbers of nodes.

Each of the two or more node groups has a condition for jobs to be assigned thereto. A condition for jobs to be assigned is defined using the planned node count of a job. The planned node count of a job here indicates the number of nodes to be used for the job. A job is a series of information processing, which is batch processing. A job includes a script file or a user program, for example. The information processing apparatus 10 receives a request to execute a job from a user. At this time, the planned node count of the job may be specified. In addition, the maximum execution time of the job may also be specified. For example, the group information 13 indicates ranges of planned node counts to be handled respectively by the node groups.

The ranges of planned node counts to be handled respectively by the two or more node groups may automatically be calculated on the basis of the group count and the number of nodes of the node set 20. For example, the ranges of planned node counts to be handled respectively by the two or more node groups are determined such that the node groups have an equal ratio of the upper and lower limits in their ranges of planned node counts. The ratio of the upper and lower limits in a range of planned node counts may be called job granularity.

As an example, the group information 13 indicates that the node set 20 is divided into node groups G and H. The node group G includes nodes #1 to #6, and the node group H includes nodes #7 to #12. The node group G handles jobs that have small planned node counts (for example, jobs whose planned node counts are less than or equal to a threshold). The node group H handles jobs that use large planned node counts (for example, jobs whose planned node counts exceed the threshold).

For each of the plurality of jobs, the processing unit 12 selects one of the two or more node groups indicated by the group information 13 according to the planned node count of the job, and causes the selected node group to execute the job. Here, the job is executed by using as many nodes as the planned node count of the job among the nodes belonging to the selected node group. The processing unit 12 performs job scheduling independently for each node group, for example. The scheduling for a certain node group does not influence the scheduling for the other node groups.

At this time, the processing unit 12 may assign jobs to idle nodes in order of priority of the jobs, from the highest first, within each node group. The priority may be given to the jobs in order of arrival. If the number of idle nodes is not enough for a job with high priority, the processing unit 12 may assign a job with low priority to idle nodes prior to the job with high priority. Execution of a small-scale job with low priority prior to a large-scale job with high priority may be called backfilling. Note that the backfilling does not occur across different node groups.

As a result of the above scheduling, in each of the two or more node groups, there may be waiting time after the information processing apparatus 10 receives a request to execute a job and before the job starts to execute. The processing unit 12 monitors the waiting time of each of the plurality of jobs. The processing unit 12 then generates distribution information with respect to each of the two or more node groups indicated by the group information 13. For example, the processing unit 12 generates the distribution information 15a of the node group G and the distribution information 15b of the node group H.

The distribution information of a node group is statistical information regarding the waiting times of two or more jobs executed by the node group. For example, the distribution information includes an index value indicating the width of a distribution of waiting time. This index value may be a difference between the maximum waiting time and the minimum waiting time of the two or more jobs executed by the node group. For example, the distribution information 15a of the node group G indicates a waiting time difference of 100 minutes, and the distribution information 15b of the node group H indicates a waiting time difference of 180 minutes.

The processing unit 12 changes the group count for the node set 20 on the basis of the generated distribution information. The group count may be called a division count. For example, in the case where the distribution information of at least one of the two or more node groups indicates an index value exceeding a threshold, the processing unit 12 increases the group count. In addition, for example, in the case where the distribution information of all the node groups indicates index values less than or equal to the threshold, the processing unit 12 decreases the group count. The threshold may be specified by an administrator of the node set 20 in advance.

Because of the change, the group information 13 is updated to group information 14. As an example, the group information 14 indicates that the node set 20 is divided into node groups I, J, and K. The node group I includes the nodes #1 to #4, the node group J includes the nodes #5 to #8, and the node group K includes the nodes #9 to #12. The node group I handles jobs that have small planned node counts. The node group J handles jobs that have medium planned node counts. The node group K handles jobs that have large planned node counts.

After changing the group count, the processing unit 12 may automatically calculate ranges of planned node counts to be handled respectively by the two or more new node groups, on the basis of the changed group count and the number of nodes of the node set 20. The processing unit 12 may calculate the ranges of planned node counts in the same way as done for the group information 13, such as the above-described method based on job granularity.

In addition, the processing unit 12 may determine the number of nodes to be included in each of the two or more new node groups according to a history of execution of the above plurality of jobs. For example, the processing unit 12 calculates, for each of the plurality of already executed jobs, a load value indicating the load of the job, and with respect to each of the new node groups, calculates the total load value of jobs that the node group is expected to handle. For example, the load value of a job is calculated as the product of the number of nodes actually used for the job and its execution time. Then, for example, the processing unit 12 distributes the plurality of nodes of the node set 20 among the two or more new node groups such that the number of nodes is in proportion to the total load value.

As described above, the information processing apparatus 10 of the first embodiment divides the node set into two or more node groups. The information processing apparatus 10 causes, for each of the plurality of jobs, one of the node groups to execute the job. Here, the node group that executes the job is selected according to the planned node count of the job. The information processing apparatus 10 generates distribution information regarding the waiting times of jobs with respect to each of the two or more node groups and changes the group count on the basis of the generated distribution information.

In the above-described approach, scheduling is performed for large-scale jobs that use large numbers of nodes and for small-scale jobs that use small numbers of nodes separately. This prevents a situation where early execution of a small-scale job impedes scheduling of a large-scale job and thereby causes a big delay in execution of the large-scale job. As a result, waiting time differences among the jobs are reduced, and unfairness among jobs of different scales is also alleviated, which improves the usability of the information processing system.

In addition, the group count is changed on the basis of the distribution information regarding waiting time of each node group. As compared with the case where the group count is fixed to two, an increase in the group count may reduce differences in waiting time among jobs. The differences in waiting time among jobs may depend on the number of nodes included in the node set 20 or a tendency of specified planned node counts. Therefore, dynamically changing the group count further reduces the differences in waiting time among jobs.

### Second Embodiment

A second embodiment will now be described.

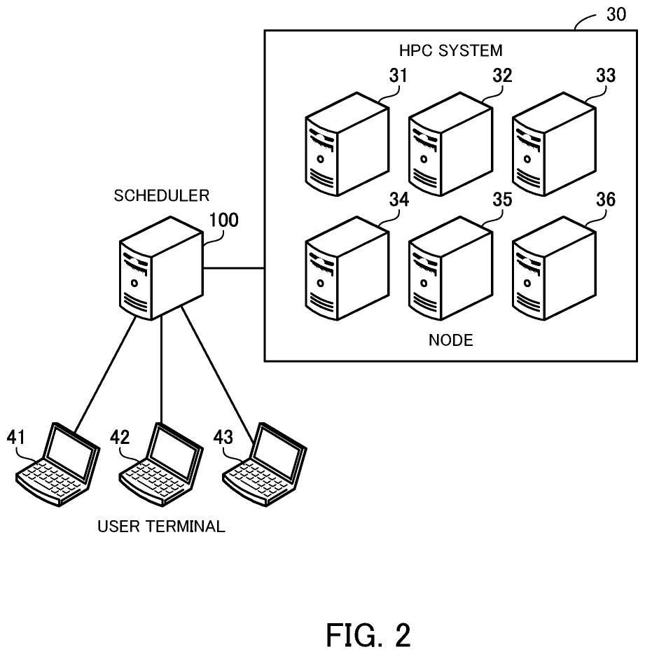

FIG. 2 illustrates an example of an information processing system according to the second embodiment.

The information processing system of the second embodiment includes an HPC system 30, a plurality of user terminals, and a scheduler 100. The plurality of user terminals include user terminals 41, 42, and 43. Each user terminal 41, 42, and 43 and the scheduler 100 communicate with each other over a network such as the Internet. The HPC system 30 and the scheduler 100 communicate with each other over a network such as a local area network (LAN).

The HPC system 30 is a large-scale information processing system that executes a plurality of jobs in parallel. The HPC system 30 includes a plurality of nodes including nodes 31, 32, 33, 34, 35, and 36. Each node has a processor (may be a processor core) and a memory and runs a program on the processor. Each node is given a node number as an identifier identifying the node. The plurality of nodes may be connected over an interconnect network in a mesh or torus topology. Two or more nodes may execute two or more processes that form a single job, in parallel.

The user terminals 41, 42, and 43 are client devices that are used by users of the HPC system 30. When a user terminal 41, 42, or 43 causes the HPC system 30 to execute a job, the user terminal 43, 42, or 43 sends a job request requesting execution of the job to the scheduler 100. The job request specifies a path to a program for activating the job, the used node count of the job, and the maximum execution time of the job. Here, the used node count of a job indicates the number of nodes used for the job. The user may be charged according to the used node count or the maximum execution time. In the case where the job is not completed within the maximum execution time after start of the job, the HPC system 30 may stop the job forcibly.

The scheduler 100 is a server device that performs job scheduling. The scheduler 100 corresponds to the information processing apparatus 10 of the first embodiment. The scheduler 100 manages a plurality of job requests received from the plurality of user terminals in a queue. In principle, the priority of jobs is set in order of arrival of their job requests. The scheduler 100 also monitors the use status of each node of the HPC system 30.

The scheduler 100 selects, for each job, as many idle nodes as the used node count specified by the job from the HPC system 30, in order from a job with the highest priority, and assigns the job to the selected nodes. The scheduler 100 notifies the HPC system 30 of the scheduling result and causes the selected nodes to execute the program for the job. Note that unexecuted jobs may remain in the queue due to a lack of idle nodes. In this case, these jobs wait until as many nodes as needed become idle.

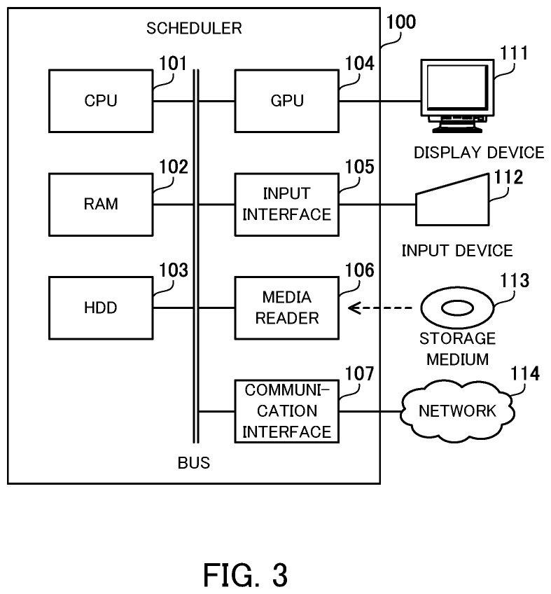

FIG. 3 illustrates a block diagram illustrating an example of hardware configuration of the scheduler.

The scheduler 100 includes a CPU 101, a RAM 102, an HDD 103, a GPU 104, an input interface 105, a media reader 106, and a communication interface 107. These units provided in the scheduler 100 are connected to a bus. The nodes 31, 32, 33, 34, 35, and 36 and the user terminals 41, 42, and 43 may have the same hardware configuration as the scheduler 100. In this connection, the CPU 101 corresponds to the processing unit 12 of the first embodiment. The RAM 102 or HDD 103 corresponds to the storage unit 11 of the first embodiment.

The CPU 101 is a processor that executes program commands. The CPU 101 loads at least part of a program or data from the HDD 103 to the RAM 102 and executes the program. The scheduler 100 may be provided with a plurality of processors. A set of multiple processors may be called “a multiprocessor,” or simply “a processor.”

The RAM 102 is a volatile semiconductor memory that temporarily stores therein a program executed by the CPU 101 and data used by the CPU 101 in processing. The scheduler 100 may be provided with a different kind of memory than RAM or a plurality of memories.

The HDD 103 is a non-volatile storage device that stores therein software programs such as OS, middleware, and application software, and data. The scheduler 100 may be provided with a different kind of storage device such as a flash memory or a solid state drive (SSD) or a plurality of storage devices.

The GPU 104 outputs images to a display device 111 connected to the scheduler 100 in accordance with commands from the CPU 101. Any kind of display device such as a cathode ray tube (CRT) display, a liquid crystal display, an organic electro-luminescence (EL) display, or a projector may be used as the display device 111. Other than the display device 111, an output device such as a printer may be connected to the scheduler 100.

The input interface 105 receives an input signal from an input device 112 connected to the scheduler 100. Any kind of input device such as a mouse, a touch panel, a touchpad, or a keyboard may be used as the input device 112. A plurality of kinds of input devices may be connected to the scheduler 100.

The media reader 106 is a reading device that reads a program or data from a storage medium 113. Any kind of storage medium, i.e., a magnetic disk such as a flexible disk (FD) or an HDD, an optical disc such as a compact disc (CD) or a digital versatile disc (DVD), or a semiconductor memory may be used as the storage medium 113. For example, the media reader 106 copies, for example, a program or data read from the storage medium 113 to another storage medium such as the RAM 102 or the HDD 103. The read program is executed by the CPU 101, for example. The storage medium 113 may be a portable storage medium and may be used to distribute a program or data. In addition, the storage medium 113 and HDD 103 may be referred to as computer-readable storage media.

The communication interface 107 is connected to a network 114 and communicates with the nodes 31, 32, 33, 34, 35, and 36 and the user terminals 41, 42, and 43 over the network 114. The communication interface 107 may be a wired communication interface that is connected to a wired communication device such as a switch or a router or may be a wireless communication interface that is connected to a wireless communication device such as a base station or an access point.

The following describes job scheduling.

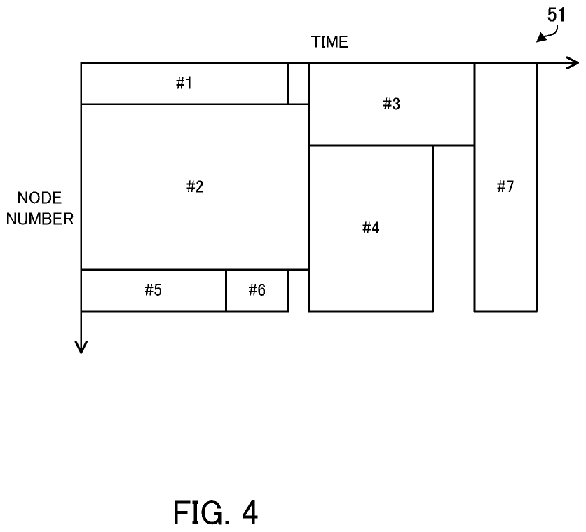

FIG. 4 illustrates a first example of scheduling result.

The graph 51 represents a result of assigning a plurality of jobs to nodes. The vertical axis of the graph 51 represents node number, whereas the horizontal axis thereof represents time. The node number decreases as the vertical axis goes upward, and the node number increases as the vertical axis goes downward. The further to the left on the horizontal axis, the older the time, and the further to the right on the horizontal axis, the newer the time. The scheduler 100 manages computing resources in the two-dimensional plane of node×time and allocates each job a rectangular resource area.

The scheduler 100 performs the scheduling using a bottom left fill (BLF) algorithm. The BLF algorithm first defines the entire rectangular space in which a plurality of rectangular blocks are to be placed and gives priority to the plurality of rectangular blocks. The BLF algorithm places the rectangular blocks one by one in the entire space, in order from a rectangular block with the highest priority. At this time, the BLF algorithm places a rectangular block at the most bottom (lowest) and most left part within the entire space without overlapping any other already-placed rectangular block.

By doing so, the rectangular block is placed at the lowest and most left part of the entire space. A position where the rectangular block is not able to be moved any further to the left or downwards may be called a bottom left (BL) stable point. The BLF algorithm places each of the plurality of rectangular blocks at its BL stable point, in order of priority.

The vertical axis of the graph 51 corresponds to the bottom of the BLF algorithm, whereas the horizontal axis thereof corresponds to the left side of the BLF algorithm. With this, in principle, the scheduler 100 assigns the plurality of jobs to nodes in order of priority in such a manner that these jobs start as early as possible. In the case where there are a plurality of possible assignments in which a job starts at the same start time, the scheduler 100 assigns the job to nodes with as small node numbers as possible.

In this connection, the scheduler 100 uses a backfill algorithm together with the BLF algorithm. The backfill algorithm may assign a small-scale job with low priority prior to a large-scale job with high priority. In the case where a job with high priority is a large-scale job that uses a large number of nodes, there may be a lack of idle nodes, which prevents the job from starting at this point in time. However, in the case where a job with low priority is a small-scale job that uses a small number of nodes, the job may be possible to start at the point in time. In this case, the backfill algorithm assigns the small-scale job with low priority first to reduce the number of idle nodes that are wasteful.

The graph 51 represents a scheduling result of the jobs #1 to #7 of different scales. The scheduler 100 has received job requests for the jobs #1 to #7 in this order. Therefore, the jobs #1 to #7 are arranged in order of priority, from the highest first.

The scheduler 100 first assigns the job #1 to nodes, then the job #2 to nodes with node numbers greater than those for the job #1. The number of idle nodes is not enough to execute either the job #3 or #4 but is enough to execute the job #5 during the execution of the jobs #1 and #2. Therefore, the scheduler 100 assigns the job #5 to nodes with node numbers greater than those for the jobs #1 and #2 with the backfill algorithm.

The jobs #1 and #2 are not yet completed when the job #5 is completed. At this time, although the number of idle nodes is not enough to execute either the job #3 or #4 but is enough to execute the job #6. At this time, the scheduler 100 assigns the job #6 to nodes with the backfill algorithm. The job #2 is not yet completed when the jobs #1 and #6 are completed. At this time, the number of idle nodes is still not enough to execute the job #3, #4, or #7. Therefore, the scheduler 100 waits for the completion of the job #2.

When the job #2 is completed, the scheduler 100 assigns the job #3 to nodes and the job #4 to nodes with node numbers greater than those for the job #3. During the execution of the jobs #3 and #4, the number of idle nodes is not enough to execute the job #7. Even after the job #4 is completed, the number of idle nodes is still not enough to execute the job #7. Therefore, the scheduler 100 assigns the job #7 to nodes after the job #3 is completed.

In the way described above, the use of the BLF algorithm and backfill algorithm together enables the scheduler 100 to reduce the number of idle nodes that are wasteful in the HPC system 30 and improve the occupancy rate of the HPC system 30. The occupancy rate is defined as the ratio of the number of nodes executing jobs to the total number of nodes. A higher occupancy rate is desirable for the administrator of the HPC system 30.

However, in the backfill method, early execution of a small-scale job may impede scheduling of a large-scale job and thus cause a delay in the execution of the large-scale job. Therefore, a waiting time after the scheduler 100 receives a job request for the large-scale job and before the large-scale job starts may significantly be long. A short average waiting time is desirable for the users of the HPC system 30. In addition, if jobs have different waiting times, the users might have a suspicion about the fairness of the scheduling.

To deal with this, the scheduler 100 divides the node set of the HPC system 30 into a plurality of groups and assigns jobs of different scales to different groups. The scheduler 100 performs scheduling using the BLF algorithm and backfill algorithm within each group. This approach reduces influences between the jobs of different scales and prevents early execution of a small-scale job from causing a delay in execution of a large-scale job. As a result, the balance between the occupancy rate the administrator cares about and the waiting time the users care about is achieved. In the following description, divided node groups may be called “clusters.”

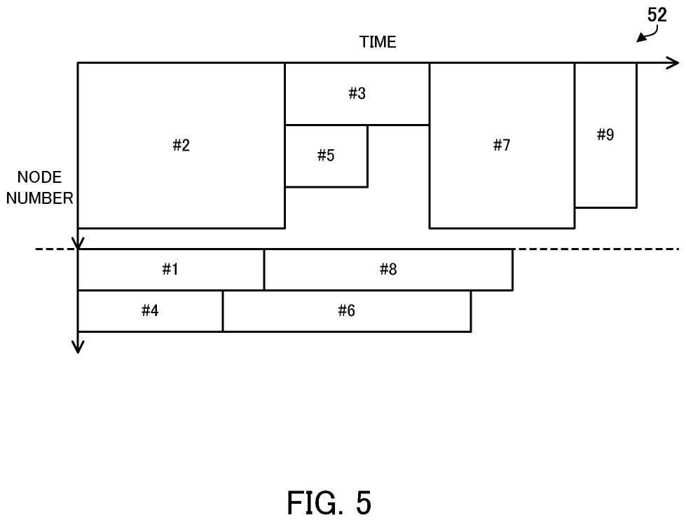

FIG. 5 illustrates a second example of scheduling result.

The graph 52 represents a result of assigning a plurality of jobs to nodes, as in the graph 51. The vertical axis of the graph 52 represents node number, whereas the horizontal axis thereof represents time. In this case, the node set of the HPC system 30 is divided into two clusters. Out of the two clusters, one cluster with smaller node numbers is used for large-scale jobs that use large numbers of nodes, and the other cluster with larger node numbers is used for small-scale jobs that use small numbers of nodes.

The graph 52 represents a scheduling result of jobs #1 to #9 of different scales. The scheduler 100 has received job requests for the jobs #1 to #9 in this order. The jobs #1 to #9 are arranged in order of priority, from the highest first. The scheduler 100 classifies the jobs #1 to #9 as large-scale jobs and small-scale jobs. In this connection, the large-scale jobs are jobs whose used node counts are greater than a threshold, and the small-scale jobs are jobs whose used node counts are less than or equal to the threshold. The jobs #2, #3, #5, #7, and #9 are large-scale jobs, and the jobs #1, #4, #6, and #8 are small-scale jobs. The scheduler 100 may manage the jobs using a plurality of queues respectively corresponding to different ranges of used node counts.

The scheduler 100 performs scheduling of the jobs #2, #3, #5, #7, and #9 within the cluster with small node numbers. Here, the scheduler 100 first assigns the job #2 to nodes, and when the job #2 is completed, the scheduler 100 assigns the jobs #3 and #5 to nodes. When the jobs #3 and #5 are completed, the scheduler 100 assigns the job #7 to nodes, and when the job #7 is completed, the scheduler 100 assigns the job #9 to nodes.

In addition, the scheduler 100 performs scheduling of the jobs #1, #4, #6, and #8 within the cluster with large node numbers. Here, the scheduler 100 first assigns the jobs #1 and #4 to nodes. When the job #4 are completed, the scheduler 100 assigns the job #6 to nodes. When the job #1 is completed, the scheduler 100 assigns the job #8 to nodes.

As described above, to divide the node set of the HPC system 30 into two clusters reduces the waiting times of large-scale jobs and thus reduces the average waiting time. In this connection, to divide the node set into three or more clusters may further reduce the waiting times.

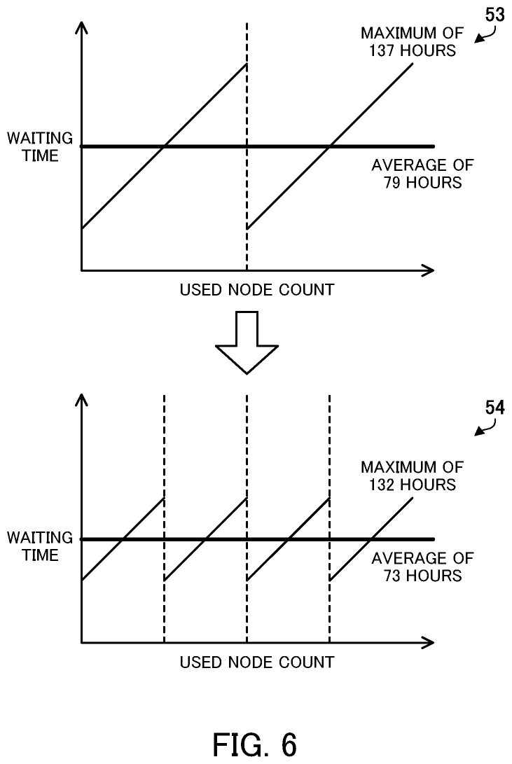

FIG. 6 illustrates graphs each representing an example of the relationship between the number of clusters and waiting time.

The graph 53 represents one simulation result regarding waiting time in the case where a node set is divided into two. The graph 54 represents one simulation result regarding waiting time in the case where the node set is divided into four. The vertical axes of the graphs 53 and 54 represent waiting time, whereas the horizontal axes thereof represent the used node count of a job.

The scheduling is performed on a cluster-by-cluster basis. Therefore, as seen in the graphs 53 and 54, within a cluster, a job with the smallest used node count in a range of used node counts handled by the cluster is likely to have a short waiting time. In addition, a job with the largest used node count in the range of used node counts handled by the cluster is likely to have a long waiting time. As seen in the graph 53, in the case where the node set is divided into two, the average waiting time of jobs with different used node counts is about 79 hours and the maximum waiting time of the jobs is 137 hours. On the other hand, as seen in the graph 54, in the case where the node set is divided into four, the average waiting time of jobs with different used node counts is about 73 hours and the maximum waiting time of the jobs is 132 hours.

As described above, an increase in the division count may reduce the average waiting time and the maximum waiting time. However, if the division count is too large, the use efficiency of nodes may decrease, the number of idle nodes that are wasteful may increase, and the occupancy rate of the HPC system 30 may decrease. To deal with these, the scheduler 100 dynamically changes the division count on the basis of the most recent execution history of jobs. After that, according to the changed division count, the scheduler 100 calculates ranges of used node counts to be handled respectively by the new clusters and determines the cluster size of each cluster. In this connection, the cluster size of a cluster indicates the number of nodes belonging to the cluster.

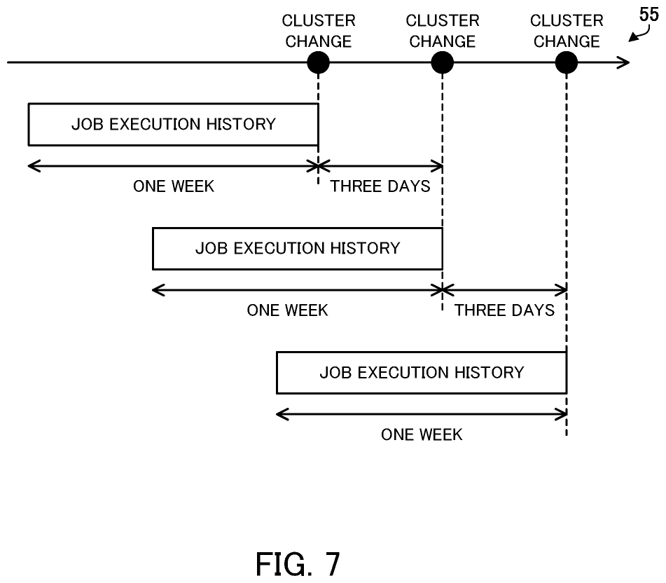

FIG. 7 illustrates an example of timing of cluster changes.

The scheduler 100 changes clusters on a periodic basis. For example, the scheduler 100 changes clusters every three days. In the cluster change, the scheduler 100 analyzes a job execution history of the most recent one week and determines the number of clusters, their ranges of used node counts, and their cluster sizes. Therefore, the job execution history referenced in a cluster change and the job execution history referenced in the next cluster change overlap for four days.

In this connection, for example, the job execution history of the most recent one week is information on jobs completed within one week before an analysis day. Alternatively, the job execution history of the most recent one week may be information on jobs whose starts fall within one week before the analysis day or information on jobs whose acceptance by the scheduler 100 falls within one week before the analysis day.

In the cluster change, the scheduler 100 first determines the number of clusters, second determines a range of used node counts for each cluster, and third determines the cluster size of each cluster. To determine the number of clusters, the scheduler 100 calculates the waiting time difference of each existing cluster.

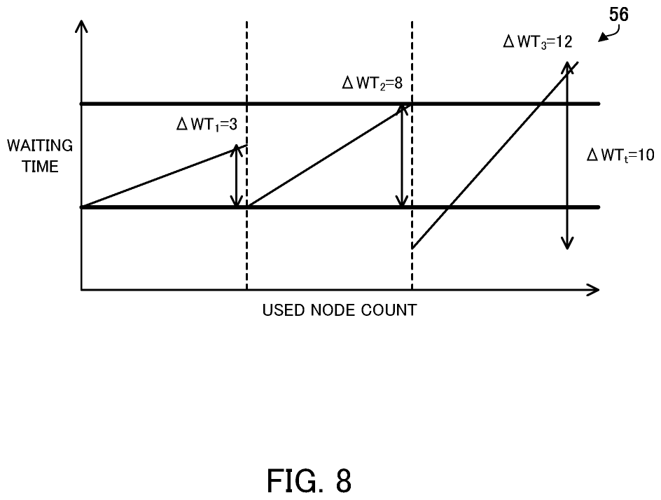

FIG. 8 illustrates a graph representing an example of the waiting time differences of clusters.

The graph 56 represents the actual waiting times of jobs executed within the most recent one week. The vertical axis of the graph 56 represents waiting time, whereas the horizontal axis thereof represents the used node count of a job. The scheduler 100 classifies the waiting times of the plurality of jobs executed within the most recent one week according to the clusters that have executed the jobs. Thereby, a distribution of waiting time is computed for each cluster. The scheduler 100 calculates the waiting time difference between the maximum and minimum values of the waiting times for each cluster.

The graph 56 represents a distribution of waiting time in the case where the number of clusters is three. As seen in the example of the graph 56, a waiting time difference ΔWT_{L} of 3 hours is calculated for a cluster that handles jobs with small used node counts. A waiting time difference ΔWT₂ of 8 hours is calculated for a cluster that handles jobs with medium used node counts. A waiting time difference ΔWT₃ of 12 hours is calculated for a cluster that handles jobs with large used node counts.

The administrator of the HPC system 30 previously sets a threshold ΔWTₜ for the waiting time difference. The threshold ΔWTₜ indicates an acceptable variation in waiting time for the administrator. For example, the threshold ΔWTₜ is set to 10 hours. The scheduler 100 compares the waiting time difference ΔWTᵢ of each cluster with the threshold ΔWTₜ. If the waiting time difference ΔWTᵢ of at least one cluster exceeds the threshold ΔWTₜ, the scheduler 100 increases the number of clusters by one. By doing so, a decrease in the waiting time difference of each cluster is expected. If the waiting time differences ΔWTᵢ of all clusters are less than the threshold ΔWTₜ, the scheduler 100 decreases the number of clusters by one. This is because the current number of clusters may be too large and this may decrease the occupancy rate of the HPC system 30.

In this connection, the above method of using the waiting time differences of a plurality of clusters is just an example. The scheduler 100 may employ another method. For example, in the case where a predetermined proportion of the clusters have waiting time differences exceeding the threshold, the scheduler 100 may increase the number of clusters by one. In addition, the scheduler 100 may set a threshold for determining to increase the number of clusters and a threshold for determining to decrease the number of clusters separately so as not to repeat the increase and decrease in the number of clusters within a short period of time.

When the number of clusters is determined, the scheduler 100 calculates ranges of used node counts as conditions for jobs to be assigned to the respective clusters, on the basis of the number of clusters.

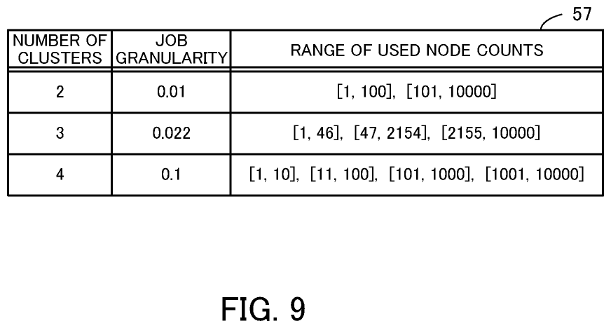

FIG. 9 illustrates an example of a table indicating used node count conditions.

The scheduler 100 calculates, for each cluster, a range of used node counts in such a manner that the plurality of clusters have equal job granularity. In the second embodiment, the “job granularity” is the ratio of the lower limit to the upper limit in a range of used node counts. A high job granularity means that jobs executed in the same cluster have small differences in the used node count. A low job granularity means that jobs executed in the same cluster have large differences in the used node count. As the job granularity increases, the average waiting time of jobs decreases. To equalize the job granularity among the plurality of clusters minimizes the average waiting time over all the clusters.

Here, the upper limit N_{z} on the used node count of a job that a cluster Z handles is defined as N\hat{ }(Z/X), where N denotes the maximum value of the used node count specified by a job, X denotes the number of clusters, and Z (Z=1 to X) denotes a cluster number. With this definition, the X clusters have equal job granularity.

The table 57 represents the correspondence relationship among the number of clusters, job granularity, and ranges of used node counts, set for the respective clusters, in the case of N=10000. The scheduler 100 may hold the table 57 and change the clusters with reference to the table 57. Alternatively, the scheduler 100 may change the clusters using the above equation, without holding the table 57.

In the case of N=10000 and X=2, the job granularity is equal to 0.01. In this case, the used node counts that the cluster 1 handles are in a range of 1 to 100, inclusive, the used node counts that the cluster 2 handles are in a range of 101 to 10000, inclusive. In the case of N=10000 and X=3, the job granularity is equal to 0.022. In this case, the used node counts that the cluster 1 handles are in a range of 1 to 46, inclusive, and the used node counts that the cluster 2 handles are in a range of 47 to 2154, inclusive, and the used node counts that the cluster 3 handles are in a range of 2155 to 10000. In the case of N=10000 and X=4, the job granularity is equal to 0.1. In this case, the used node counts that the cluster 1 handles are in a range of 1 to 10, inclusive, and the used node counts that the cluster 2 handles are in a range of 11 to 100, inclusive, the used node counts that the cluster 3 handles are in a range of 101 to 1000, and the used node counts that the cluster 4 handles are in a range of 1001 to 10000.

After the number of clusters and, for each cluster, a range of used node counts are determined, the scheduler 100 determines the number of nodes to be included in each cluster on the basis of a job execution history. The scheduler 100 estimates the load of each new cluster and distributes the nodes among the clusters in such a manner that the number of nodes is in proportion to the estimated load.

More specifically, the scheduler 100 re-distributes a plurality of jobs executed within the most recent one week among the plurality of new clusters according to their used node counts. In addition, the scheduler 100 calculates, with respect to each of the plurality of jobs executed within the most recent one week, the product of the used node count and the actual execution time as a load value. The actual execution time of a job may be an actual elapsed time from the start to the completion of the job. If a job is interrupted halfway, the execution time of the job does not need to include the interruption time. The scheduler 100 adds the load values of the jobs belonging to each of the plurality of new clusters to thereby calculate the total load value. The scheduler 100 determines the number of nodes to be included in each of the plurality of clusters in such a manner that the number of nodes is in proportion to the total load value.

For example, assume that the HPC system 30 includes 50000 nodes and that the total load value of the cluster 1 is 500000 (the number of nodes×time), the total load value of the cluster 2 is 200000 (the number of nodes×time), and the total load value of the cluster 3 is 300000 (the number of nodes×time). In this case, the ratio of these three clusters in terms of the total load value is 50%:20%:30%. Therefore, for example, the scheduler 100 determines that the number of nodes in the cluster 1 is 25000, the number of nodes in the cluster 2 is 10000, and the number of nodes in the cluster 3 is 15000.

In this connection, it is preferable that the scheduler 100 adjust the cluster size of each cluster so that the upper limit on the used node count of a job handled by the cluster and the cluster size satisfy a fixed constraint condition.

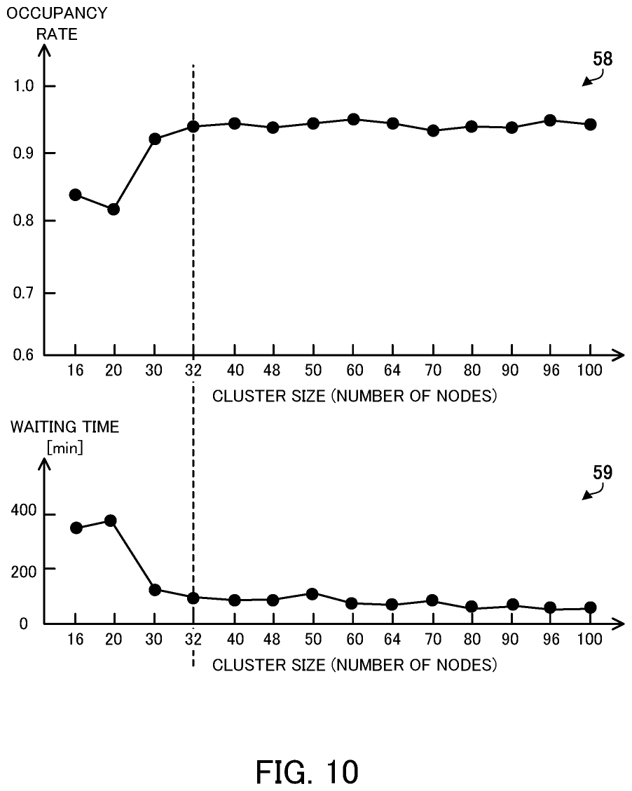

FIG. 10 illustrates graphs representing the relationship between cluster size and occupancy rate and the relationship between cluster size and waiting time.

The graphs 58 and 59 represent simulation results obtained in the case where the upper limit on the used node count that is specified by a job is 16. The graph 58 represents the relationship between cluster size and occupancy rate. The vertical axis of the graph 58 represents the occupancy rate, whereas the horizontal axis thereof represents the cluster size. The graph 59 represents the relationship between cluster size and waiting time. The vertical axis of the graph 59 represents the waiting time, whereas the horizontal axis thereof represents the cluster size.

As seen in the graph 58, in the case where the number of nodes included in a cluster is greater than or equal to 32 that is twice the upper limit on the used node count of a job, the occupancy rate is approximately constant. In the case where the number of nodes included in a cluster is less than 32, however, the occupancy rate drastically decreases. In addition, as seen in the graph 59, in the case where the number of nodes included in a cluster is greater than or equal to 32 that is twice the upper limit on the used node count of a job, the average waiting time is approximately constant. In the case where the number of nodes included in a cluster is less than 32, however, the average waiting time drastically increases.

Therefore, when determining the cluster size of each cluster, the scheduler 100 sets the lower limit on the cluster size to twice the upper limit on the used node count of a job handled by the cluster. In the case where the cluster size of a cluster calculated based on the ratio in terms of total load value is below the lower limit, the scheduler 100 adjusts the cluster size to the lower limit. In this case, the scheduler 100 adjusts the cluster sizes of the other clusters accordingly in such a manner that the cluster size of each of the other clusters is in proportion to the total load value.

For example, in the above calculation example, the number of nodes in the cluster 3 is calculated as 15000, less than twice the upper limit of 10000 on the used node count of a job handled by the cluster 3. Therefore, the scheduler 100 adjusts the number of nodes in the cluster 3 to 20000. Then, the scheduler 100 distributes the remaining 30000 nodes between the clusters 1 and 2 at their ratio in terms of total load value. By doing so, the number of nodes in the cluster 1 is adjusted to 21429, and the number of nodes in the cluster 2 is adjusted to 8571. The adjusted number of nodes in each cluster 1 and 2 satisfies the above constraint condition.

The following describes the functions and operations of the scheduler 100.

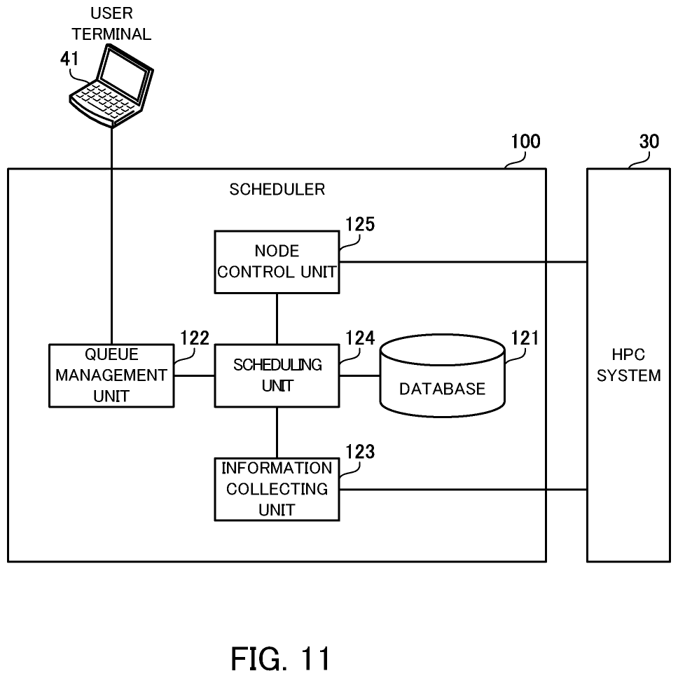

FIG. 11 illustrates a block diagram illustrating an example of functions of the scheduler.

The scheduler 100 includes a database 121, a queue management unit 122, an information collecting unit 123, a scheduling unit 124, and a node control unit 125. The database 121 is implemented by using a storage space of the RAM 102 or HDD 103, for example. The queue management unit 122, information collecting unit 123, scheduling unit 124, and node control unit 125 are implemented by the CPU 101 executing the intended program.

The database 121 stores therein cluster information indicating a range of nodes belonging to each divided cluster and a range of used node counts set for each divided cluster. The database 121 also stores therein node information indicating the current use status of each node included in the HPC system 30. The database 121 also stores therein history information indicating a history of jobs executed in the past.

The queue management unit 122 receives job requests from user terminals including the user terminals 41, 42, and 43. The queue management unit 122 manages a plurality of queues respectively corresponding to a plurality of clusters determined by the scheduling unit 124. The queue management unit 122 inserts a received job request at the end of the queue corresponding to the specified used node count. The queue management unit 122 retrieves a job request from a queue in response to a request from the scheduling unit 124 and outputs the job request to the scheduling unit 124.

The information collecting unit 123 collects node information indicating the latest use status of each node from the HPC system 30. The node information indicates whether each node currently executes a job and also indicates, when a node currently executes a job, the identifier of the currently executed job. The information collecting unit 123 detects the starts and ends of jobs, and when detecting the start or end of a job, collects updated node information. For example, when a job starts or ends, the nodes in the HPC system 30 notify the scheduler 100 of this event. Then, the scheduler 100 requests each node of the HPC system 30 to provide the current status of the node.

Each time the scheduling unit 124 detects the start or end of a job, the scheduling unit 124 performs scheduling to assign waiting jobs to nodes. The scheduling unit 124 extracts a job request from the queue management unit 122 with respect to each of the plurality of clusters and performs scheduling using the BLF algorithm and backfill algorithm. The scheduling for the plurality of clusters may be performed independently and in parallel. In the case of assigning a waiting job in a queue to idle nodes, the scheduling unit. 124 notifies the node control unit 125 of the assignment result.

In addition, the scheduling unit 124 updates the cluster information on a periodic basis. The scheduling unit 124 calculates the waiting time difference of each of the plurality of clusters on the basis of the waiting times of jobs executed in the past and changes the number of clusters on the basis of the waiting time differences. Then, the scheduling unit 124 determines ranges of used node counts to be handled respectively by the clusters on the basis of the number of clusters and the maximum value of the used node count of a job. Then, the scheduling unit 124 determines the cluster size of each cluster on the basis of the used node count and execution time of each past job and the range of used node counts handled by each cluster. The cluster change is reflected on jobs that are to be executed thereafter and is not reflected on currently executed jobs.

The node control unit 125 instructs the HPC system 30 to start a job. For example, the node control unit 125 sends an activation command including a path to a program to be activated, to nodes assigned the job by the scheduling unit 124.

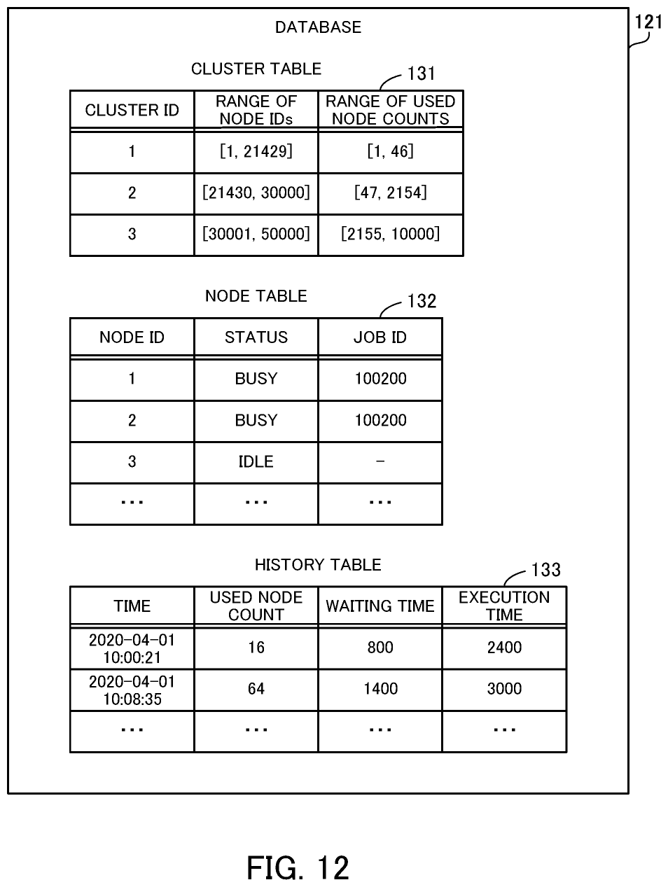

FIG. 12 illustrates an example of a cluster table, a node table, and a history table.

The cluster table 131 is stored in the database 121. The cluster table 131 indicates the correspondence relationship among cluster ID, a range of node IDs, and a range of used node counts. The range of node IDs indicates nodes belonging to a cluster. The range of used node counts indicates a condition for jobs that a cluster handles.

For example, the cluster 1 includes nodes with node numbers 1 to 21429 and handles jobs whose used node counts are in a range of 1 to 46. In addition, the cluster 2 includes nodes with node numbers 21430 to 30000 and handles jobs whose used node counts are in a range of 47 to 2154. The cluster 3 includes nodes with node numbers 30001 to 50000 and handles jobs whose used node counts are in a range of 2155 to 10000.

The node table 132 is stored in the database 121. The node table 132 indicates the correspondence relationship among node ID, status, and job ID. The status is a flag indicating whether a node currently executes a job (i.e., busy). The job ID is the identifier of a currently executed job.

The history table 133 is stored in the database 121. The history table 133 indicates the correspondence relationship among time, used node count, waiting time, and execution time. The time is when an event of predetermined type occurs with respect to a job. The time is, for example, the time of reception of a job request by the scheduler 100, the start time of the job, or the end time of the job.

The used node count here is the actual number of nodes used by a job. The waiting time is an actual elapsed time after the reception of a job request by the scheduler 100 and before the start of the job. The execution time is an actual elapsed time between the start and the end of the job. The waiting time and execution time are represented in units of minutes, for example. To change clusters, the scheduling unit 124 extracts records with times falling within the most recent one week from the history table 133.

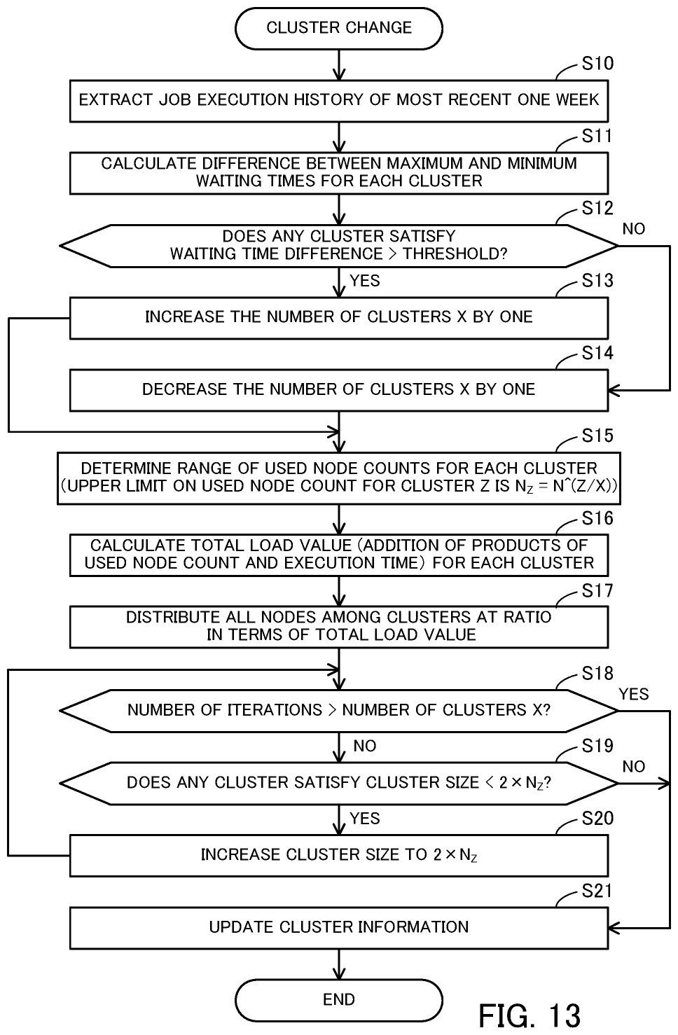

FIG. 13 is a flowchart illustrating how to change clusters.

(S10) The scheduling unit 124 extracts a job execution history of the most recent one week.

(S11) The scheduling unit 124 classifies a plurality of jobs executed within the most recent one week into a plurality of current clusters according to their used node counts. The scheduling unit 124 determines, for each cluster, the maximum and minimum values of the waiting times and calculates the waiting time difference between the maximum and minimum waiting times.

(S12) The scheduling unit 124 compares the waiting time difference of each of the plurality of clusters with a threshold preset by the administrator of the HPC system 30. The scheduling unit 124 determines whether there is a cluster whose waiting time difference exceeds the threshold. If the waiting time difference of at least one cluster exceeds the threshold, the process proceeds to step S13. If the waiting time differences of all the clusters are less than or equal to the threshold, the process proceeds to step S14.

(S13) The scheduling unit 124 increases the number of clusters X by one (X=X+1). Then, the process proceeds to step S15.

(S14) The scheduling unit 124 decreases the number of clusters X by one (X=X−1).

(S15) The scheduling unit 124 determines a range of used node counts for each of the X clusters on the basis of the number of clusters X and the maximum value N of the used node count of a job. At this time, the scheduling unit 124 makes this determination such that the clusters have equal job granularity. For example, the scheduling unit 124 determines N\hat{ }(Z/X) as the upper limit N_{z} on the used node count of a job handled by the cluster Z.

(S16) The scheduling unit 124 re-classifies the plurality of jobs executed within the most recent one week into the new X clusters according to their used node counts. The scheduling unit 124 then calculates, for each job, the product of the used node count and the execution time as its load value, and with respect to each of the X clusters, calculates the total load value that is the addition of the load values of the jobs belonging to the cluster.

(S17) The scheduling unit 124 distributes all nodes of the HPC system 30 among the X clusters in such a manner that the number of nodes is in proportion to the total load value.

(S18) The scheduling unit 124 determines whether the number of iterations of steps S19 and S20 exceeds the number of clusters X. If the number of iterations exceeds the number of clusters X, the process proceeds to step S21; otherwise, the process proceeds to step S19.

(S19) The scheduling unit 124 determines whether the X clusters include a cluster whose cluster size (the number of nodes included in the cluster) is less than twice the upper limit N_{z} on the used node count of a job handled by the cluster. If such a cluster exists, the process proceeds to step S20; otherwise, the process proceeds to step S21.

(S20) The scheduling unit 124 increases the cluster size of a cluster whose cluster size is less than 2×N_{z}, to 2×N_{z}. Then, the process returns back to step S18.

(S21) The scheduling unit 124 fixes the cluster sizes of the X clusters. The scheduling unit 124 then updates the cluster information so that the cluster information indicates the correspondence relationship among determined cluster, a range of used node counts, and cluster size.

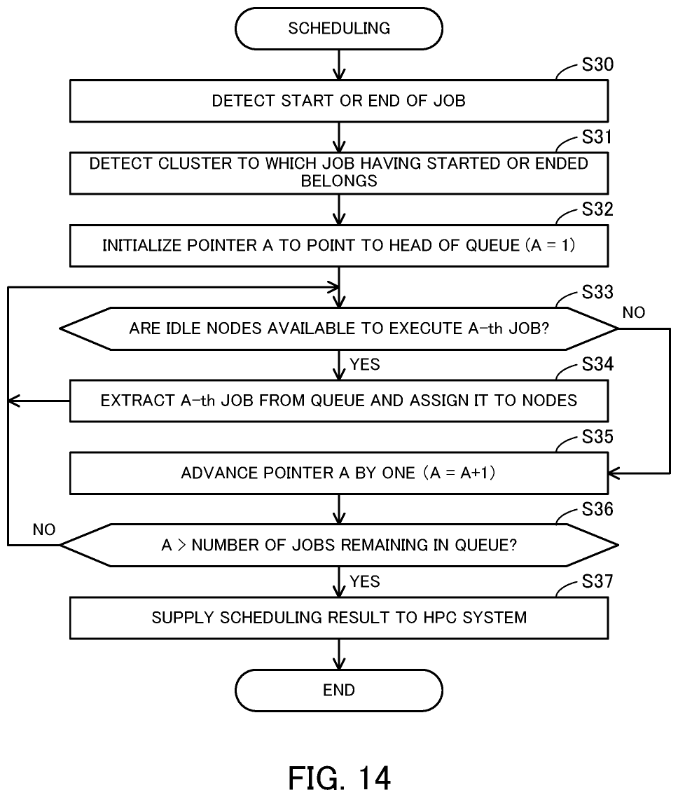

FIG. 14 is a flowchart illustrating a scheduling procedure.

(S30) The information collecting unit 213 detects the start or end of any job.

(S31) The scheduling unit 124 detects, among the divided X clusters, a cluster Z that handles the job detected to have started or ended at step S30.

(S32) The scheduling unit 124 initializes a pointer A to point to the head of the queue corresponding to the cluster Z among the X queues (A=1)).

(S33) The scheduling unit 124 detects the used node count specified by the A-th job in the queue and determines whether the number of idle nodes is greater than or equal to the used node count, i.e., whether idle nodes are available to execute the A-th job. If such idle nodes are available, the process proceeds to step S34; otherwise, the process proceeds to step S35.

(S34) The scheduling unit 124 extracts the A-th job from the queue and assigns the A-th job to as many idle nodes as its used node count. The scheduling unit 124 registers the assignment information as a tentative scheduling result in the node table 132. Then, the process returns back to step S33. In this connection, step S34 executed in the case where A is two or greater is equivalent to backfilling.

(S35) The scheduling unit 124 advances the pointer A by one (A=A+1).

(S36) The scheduling unit 124 determines whether A is greater than the number of jobs remaining in the queue. If A is greater than the number of remaining jobs, the process proceeds to step S37; otherwise, the process returns back to step S33.

(S37) The scheduling unit 124 reads information registered as the tentative scheduling result from the node table 132. The node control unit 125 supplies the scheduling result to the HPC system 30. The scheduling unit 124 deletes the information registered as the tentative scheduling result from the node table 132.

As described above, the scheduler 100 of the second embodiment performs the job scheduling using the BLF algorithm and backfill algorithm. This improves the occupancy rate of the HPC system 30 and thus the operating efficiency of the HPC system 30.

In addition, the scheduler 100 divides the node set into two or more clusters, and with respect to each job, causes an appropriate one of the clusters to execute the job according to the used node count. That is, the scheduling is performed for large-scale jobs and for small-scale jobs separately. This approach reduces the situation where early start of a small-scale job impedes the scheduling of a large-scale job, and thus prevents an increase in the waiting time of the large-scale job. As a result, the average waiting time and maximum waiting time are reduced. In addition, the waiting time differences among jobs are reduced, which improves the usability of the HPC system 30.

In addition, the number of clusters is dynamically changed on the basis of the waiting time differences of clusters. Therefore, as compared with the case where the number of clusters is fixed, the waiting time differences among jobs are further reduced and thus the average waiting time and the maximum waiting time are reduced. In addition, the situation where the number of clusters becomes too large and the occupancy rate decreases is prevented. In addition, the ranges of used node counts to be handled respectively by the clusters are determined in such a manner that the clusters have equal job granularity. This further reduces the average waiting time. In addition, the cluster size of each cluster is determined so as to reflect the loads of past jobs. This further reduces the average waiting time. In addition, the cluster size of each cluster is adjusted so that the cluster size does not fall below twice the upper limit on the used node count of a job. This prevents a decrease in the occupancy rate and an increase in the waiting time due to a lack in the number of nodes.

According to one aspect, the waiting time differences among jobs that use different numbers of nodes are reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory that stores therein group information indicating two or more node groups generated by dividing a set of nodes including a plurality of nodes used to execute a plurality of jobs; and
a processor that is configured to perform a process including:
causing, with respect to each of the plurality of jobs, one node group to execute the each of the plurality of jobs, the one node group being selected according to a planned node count of the each of the in plurality of jobs from the two or more node groups indicated by the group information, the planned node count indicating a number of nodes to be used for the each of the plurality of jobs,
generating, with respect to each of the two or more node groups, distribution information regarding waiting times of two or more jobs executed by the each of the two or more node groups among the plurality of jobs, and
changing a group count of the two or more node groups, based on the distribution information.

2. The information processing apparatus according to claim 1, wherein
the distribution information includes an index value indicating a width of a distribution of the waiting times, and
the changing of the group count includes increasing the group count upon determining that the two or more node groups includes a node group whose index value exceeds a threshold.

3. The information processing apparatus according to claim 1, wherein the distribution information indicates a difference between maximum and minimum values of the waiting times.

4. The information processing apparatus according to claim 1, wherein the process further includes determining, for each of the two or more node groups after the changing, a range of planned node counts to be handled by the each of the two or more node groups after the changing in such a manner that the two or more node groups after the changing have an equal ratio of an upper limit and a lower limit in the range of planned node counts.

5. The information processing apparatus according to claim 1, wherein the process further includes determining a number of nodes to be included in each of the two or more node groups after the changing in such a manner that the number of nodes is in proportion to a product of an execution time of a job with the planned node count handled by the each of the two or more node groups after the changing among the plurality of jobs and the planned node count of the job.

6. The information processing apparatus according to claim 1, wherein the process further includes determining a number of nodes to be included in each of the two or more node groups after the changing in such a manner as to exceed twice an upper limit on the planned node count handled by the each of the two or more node groups after the changing.

7. A job scheduling method comprising:
dividing, by a processor, a set of nodes including a plurality of nodes to execute a plurality of jobs into two or more node groups;
causing, by the processor, with respect to each of the plurality of jobs, one node group to execute the each of the plurality of jobs, the one node group being selected according to a planned node count of the each of the plurality of jobs from the two or more node groups, the planned node count indicating a number of nodes to be used for the each of the plurality of jobs;
generating, by the processor, with respect to each of the two or more node groups, distribution information regarding waiting times of two or more jobs executed by the each of the two or more node groups among the plurality of jobs; and
changing, by the processor, a group count of the two or more node groups, based on the distribution information.
